(19) United States
(12) Patent Application Publication
(10) Pub. No.: US 2009/0106130 A1
(43) Pub. Date: Apr. 23, 2009

(54) Systems and Methods Involving Rotable Components

(75) Inventor: Daniel E. Quinn, Windsor, CT (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: UNITED TECHNOLOGIES CORP., Hartford, CT (US)

(21) Appl. No.: 11/873,569

(22) Filed: Oct. 17, 2007

(51) Int. Cl. G06Q 10/00; G01M 15/00

(52) U.S. Cl. 705/28; 705/1

(57) ABSTRACT

Systems and methods involving rotable gas turbine engine components are provided. In this regard, a representative system includes: a component pool control system; an inventory system operative to store inventory information corresponding to a current inventory of rotable components and to provide the inventory information to the component pool control system; and an inspection system operative to store inspection information corresponding to analyzed one of the rotable components and to provide the inspection information to the component pool control system.

### BACKGROUND

1. Technical Field

The disclosure generally relates to repair and/or replacement of gas turbine engine components.

2. Description of the Related Art

Gas turbine engine components tend to be relatively expensive items. Not only are such components expensive to manufacture, these components oftentimes are subjected to wear, which can lead to component repair and/or replacement. Repair and replacement also are expensive procedures owing to the technical support required to perform such procedures and the indirect costs associated with removing an engine with which the component is associated from service during the performance of such procedures.

### SUMMARY

Systems and methods involving rotable gas turbine engine components are provided. In this regard, an exemplary embodiment of a method comprises: obtaining access to a rotable component; analyzing the component; removing a corresponding rotable component from service; replacing the removed component with the component previously analyzed; analyzing the removed component; determining that the component and the corresponding component exhibit different operational usage times; and correlating information obtained during the analyzing of the component and the corresponding component relative to the usage times.

Another exemplary embodiment of a method comprises: analyzing a component; removing a corresponding component from an aircraft engine based, at least in part, on a request for obtaining information pertaining to the corresponding component, the request being provided by a component pool control system that is operative to coordinate compilation of a database of information corresponding to rotable components; replacing the removed component with the component previously analyzed; analyzing the removed component; enabling the component pool control system to augment the database with information corresponding to the component and to the corresponding component; and using information form the database to facilitate at least one of repair and replacement of another corresponding component.

An exemplary embodiment of a system comprises: a component pool control system; an inventory system operative to store inventory information corresponding to a current inventory of rotable components and to provide the inventory information to the component pool control system; and an inspection system operative to store inspection information corresponding to analyzed one of the rotable components and to provide the inspection information to the component pool control system.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale. Moreover, in the drawings, like reference numerals designate corresponding parts throughout the several views.

FIG. 1 is a flowchart depicting an embodiment of a method involving rotable gas turbine engine components.

FIG. 2 is a schematic diagram depicting an exemplary embodiment of a system involving rotable gas turbine engine components.

FIG. 3 is a flowchart depicting another embodiment of a method involving rotable gas turbine engine components.

### DETAILED DESCRIPTION

Systems and methods involving rotable gas turbine engine components are provided, several exemplary embodiments of which will be described in detail. In this regard, some embodiments involve maintaining a pool of rotable components that can be analyzed and then swapped with corresponding components. By way of example, the rotable components can be of different configurations that can be analyzed to determine various characteristics. For instance, material composition, tensile strength, and cooling airflow requirements, among others can be analyzed. Each of the components can then be swapped and used as replacement parts for corresponding components that are in service, for example. The corresponding replaced components then can be analyzed, thereby increasing the information available with respect to like components.

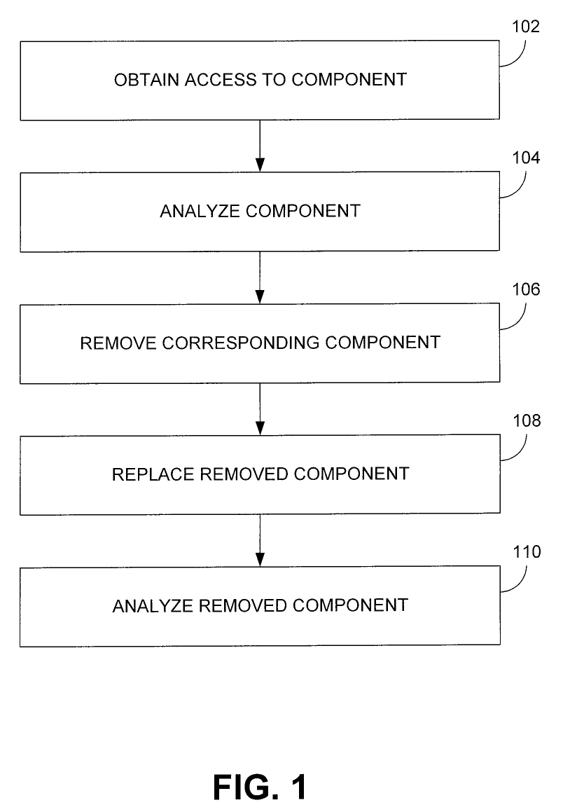

An exemplary embodiment of a method involving rotable components is depicted in FIG. 1. As shown in FIG. 1, the method may be construed as beginning at block 102, in which access to a component is obtained. By way of example, access to the component can be obtained by purchasing the component or by other arrangements such as loan and/or lease.

In block 104, the component is analyzed. By way of example, the component can be analyzed to determine one or more of various characteristics of the component. In some embodiments, one or more of the characteristics can relate to materials and/or structure of the component, whereas others of the characteristics can relate to operational characteristics.

In block 106, a corresponding component is removed. For instance, when the component to which access has previously been obtained is a turbine vane, a corresponding turbine vane (e.g., a turbine vane of like part number) can be removed from service. Typically, this is accomplished by removing the component during a maintenance procedure on an engine in which the component is installed. Then, as depicted in block 108, the removed component is replaced with the component that was previously analyzed. In this manner, another component is made accessible for use and/or analysis. Notably, in this embodiment, only one extra component (i.e., the original component to which access was obtained) was added to a rotable pool of such components. This is in contrast to a method that involves testing of new components without an emphasis being placed upon testing components currently in service.

In block 110, the removed component also is analyzed. Since the removed component may have a different number of hours of usage, analysis of the removed component can provide additional useful information regarding the life cycle of similar components.

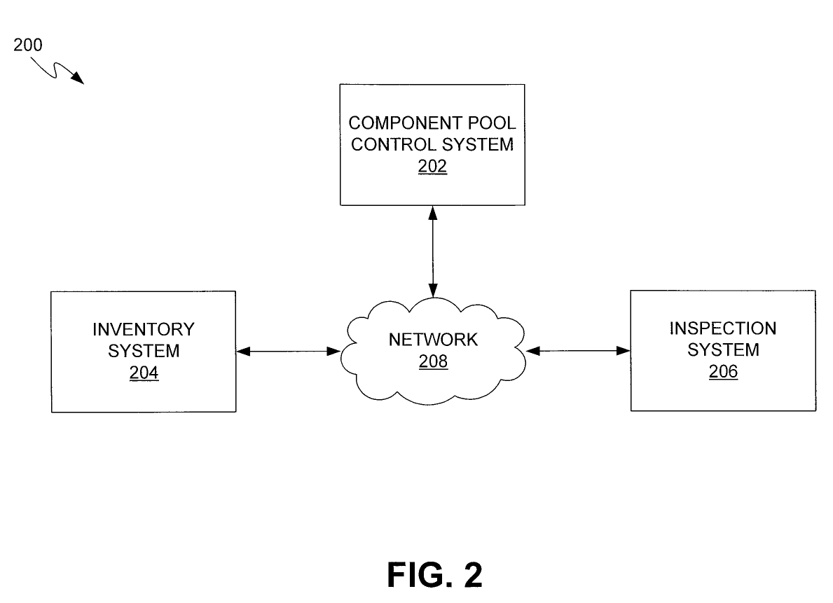

An exemplary embodiment of a system involving rotable components is depicted schematically in FIG. 2. As shown in FIG. 2, system 200 incorporates a component pool control system 202, an inventory system 204 and an inspection system 206. In the embodiment of FIG. 2, component pool control system 202, inventory system 204 and inspection system 206 communicate via a communication network 208. Notably, the communication network can include one or more of various network types (e.g., Internet Protocol, telephone) and/or configurations (e.g., wired/wireless, Local Area Network).

The inventory system 204 stores information corresponding to a current inventory of rotable components. By way of example, such information can include part numbers, serial numbers, current location of components, quantity of components available, condition of components (e.g., new or repaired), interchangability requirements with other part numbers, nozzle area, base material, coating material, and value. As another example, such information can include information regarding the availability of uninstalled components and the predicted availability of currently installed components. Notably, currently installed components may be made available for various reasons, such as during periodic maintenance. By using the inventory system to track the engines and/or aircraft in which a component is installed and determining an appropriate periodic maintenance cycle, potential availability for component removal and/or replacement can be accomplished. Such information can be provided by the inventory system to the component pool control system.

In this regard, the component pool control system 202 stores information corresponding to the pool of rotable of components. Notably, system 202 can determine swap candidates (i.e., those components that are available to be removed and/or used as replacements) based, at least in part, on current inventory and/or availability.

Inspection system 206 obtains information corresponding to components. As such, the inspection system stores information obtained during one or more of various tests, such as information corresponding to: 1) characterization of internal and/or external geometry via methods such as gage measurements, CMM, CT scan, ATOS scan; 2) base material and coating chemistry and microstructure; 3) airflow characteristics for internally cooled turbine vanes/blades (e.g., mass flow rate versus pressure ratio); and 4) previous repair such as may be determined by destructive or non destructive evaluation. Information obtained and corresponding to the components also is provided to the component pool control system.

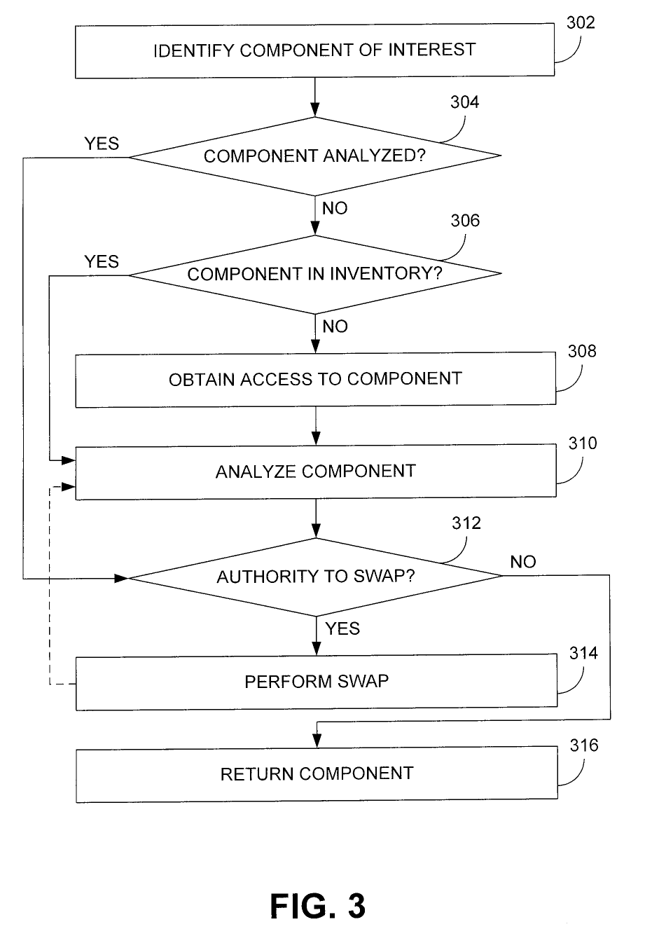

Another exemplary embodiment of a method involving rotable components is depicted schematically in FIG. 3. As shown in FIG. 3, the method may be construed as beginning in block 302, in which a component of interest is identified. In block 304, a determination is made as to whether the component has been analyzed. If it is determined that the component has not been analyzed, the process may proceed to block 306, in which a determination is made as to whether the component is present in inventory. If it is determined that the component is not present in inventory, the process may proceed to block 308, in which access to a component is obtained. Thereafter, such as depicted in block 310, the component is analyzed. In block 312, a determination is made as to whether authority to swap the component exists (i.e., can the component be put into service and replaced with another). If it is determined that authority to swap the component does exist, the process may proceed to block 314, in which a swap is performed. That is, the component previously analyzed can be used as a replacement component for a component that is pulled out of service, for example. Notably, the component removed from service can then be analyzed, such as depicted in block 310 after which the process can proceed as previously described to blocks 312 and 314. If however, it is determined that block 312 that authority to swap is not possessed, the process may proceed to block 316, in which the component is returned.

It should be noted that in block 304, if a component of interest has been previously analyzed, the process may proceed from block 304 to block 312. Thus, if a component has been previously analyzed, a determination may be made as to whether a swap should occur in order to provide an opportunity to obtain additional information related to a corresponding component.

It should also be noted that if a component of interest is provided in inventory, the process may proceed from block 306 to block 310, in which that component is analyzed. Thereafter, the process may proceed as described before. Notably, information obtained during analysis can be stored, such as in a database, and used to facilitate repair and/or replacement of another corresponding component.

Various functionality, such as that described above in the flowcharts, can be implemented in hardware and/or software. In this regard, a computing device can be used to implement various functionality, such as that of the component pool control system 202, inventory system 204 and/or inspection system 206 depicted in FIG. 2.

In terms of hardware architecture, such a computing device can include a processor, memory, and one or more input and/or output (I/O) device interface(s) that are communicatively coupled via a local interface. The local interface can include, for example but not limited to, one or more buses and/or other wired or wireless connections. The local interface may have additional elements, which are omitted for simplicity, such as controllers, buffers (caches), drivers, repeaters, and receivers to enable communications. Further, the local interface may include address, control, and/or data connections to enable appropriate communications among the aforementioned components.

The processor may be a hardware device for executing software, particularly software stored in memory. The processor can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). Moreover, the memory may incorporate electronic, magnetic, optical, and/or other types of storage media. Note that the memory can also have a distributed architecture, where various components are situated remotely from one another, but can be accessed by the processor.

The software in the memory may include one or more separate programs, each of which includes an ordered listing of executable instructions for implementing logical functions. A system component embodied as software may also be construed as a source program, executable program (object code), script, or any other entity comprising a set of instructions to be performed. When constructed as a source program, the program is translated via a compiler, assembler, interpreter, or the like, which may or may not be included within the memory.

The Input/Output devices that may be coupled to system I/O Interface(s) may include input devices, for example but not limited to, a keyboard, mouse, scanner, microphone, camera, proximity device, etc. Further, the Input/Output devices may also include output devices, for example but not limited to, a printer, display, etc. Finally, the Input/Output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

When the computing device is in operation, the processor can be configured to execute software stored within the memory, to communicate data to and from the memory, and to generally control operations of the computing device pursuant to the software. Software in memory, in whole or in part, is read by the processor, perhaps buffered within the processor, and then executed.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the functionality described herein can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” contains, stores, communicates, propagates and/or transports the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of a computer-readable medium include a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical).

It should be emphasized that the above-described embodiments are merely possible examples of implementations set forth for a clear understanding of the principles of this disclosure. Many variations and modifications may be made to the above-described embodiments without departing substantially from the spirit and principles of the disclosure. By way of example, it should be noted that any of the functions described above as being attributable to a single system can be performed by another system or shared by one or more systems. All such modifications and variations are intended to be included herein within the scope of this disclosure and protected by the accompanying claims.

1. A method involving rotable gas turbine engine components comprising:
obtaining access to a rotable component;
analyzing the component;
removing a corresponding rotable component from service;
replacing the removed component with the component previously analyzed;
analyzing the removed component;
determining that the component and the corresponding component exhibit different operational usage times; and
correlating information obtained during the analyzing of the component and the corresponding component relative to the usage times.

2. The method of claim 1, wherein obtaining access to the component comprises purchasing the component.

3. The method of claim 1, wherein analyzing the component comprises determining at least one operational characteristic of the component.

4. The method of claim 1, wherein analyzing the component comprises determining cooling airflow requirements of the component.

5. The method of claim 1, wherein the component is a turbine vane.

6. The method of claim 5, wherein the removed component is a turbine vane having a corresponding part number to that of the component.

7. The method of claim 1, wherein removing the corresponding component comprises removing the corresponding component during a maintenance procedure on an engine in which the corresponding component is installed.

8. The method of claim 1, further comprising determining whether authority to swap the component exists prior to removing the corresponding component from service such that the removing of the corresponding component from service and the replacing of the removed component with the component previously analyzed does not occur unless the authority to swap exists.

9. The method of claim 1, further comprising analyzing maintenance schedules such that the corresponding component and associated time period for removal are identified.

10. A system involving rotable gas turbine engine components comprising:
a component pool control system;
an inventory system operative to store inventory information corresponding to a current inventory of rotable components and to provide the inventory information to the component pool control system; and
an inspection system operative to store inspection information corresponding to analyzed one of the rotable components and to provide the inspection information to the component pool control system.

11. The system of claim 10, wherein the component pool control system is operative to determine the components to be removed from service.

12. The system of claim 11, wherein the component pool control system is operative to determine the components to be removed from service based, at least in part, on the current inventory.

13. The system of claim 10, wherein the component pool control system is operative to determine an appropriate periodic maintenance cycle available for removal of a rotable component.

14. The system of claim 10, wherein the inventory information and the inspection information is provided to the component pool control system via a communication network.

15. The system of claim 10, wherein the inspection system is operative to store inspection information corresponding to at least one of: component geometry, base material chemistry and microstructure, coating chemistry and microstructure, airflow characteristics, previous repair.

16. The system of claim 10, wherein the inventory system is operative to store inventory information corresponding to at least one of the following: part number, serial numbers of the components, current locations of the components, quantities of the components, conditions of the components, interchangability requirements with other part numbers, nozzle areas, base materials, coating materials, and value.

17. The system of claim 10, wherein the inventory system is operative to store inventory information corresponding to at least one of information regarding the availability of uninstalled components and predicted availability of currently installed components.

18. A method involving rotable gas turbine engine components comprising:
analyzing a component;
removing a corresponding component from an aircraft engine based, at least in part, on a request for obtaining information pertaining to the corresponding component, the request being provided by a component pool control system that is operative to coordinate compilation of a database of information corresponding to rotable components;
replacing the removed component with the component previously analyzed;
analyzing the removed component;
enabling the component pool control system to augment the database with information corresponding to the component and to the corresponding component; and
using information form the database to facilitate at least one of repair and replacement of another corresponding component.

19. The method of claim 18, wherein analyzing the component comprises determining at least one operational characteristic of the component.

20. The method of claim 19, wherein analyzing the component comprises determining cooling airflow requirements of the component.
